(19) United States
(12) Patent Application Publication
(10) Pub. No.: US 2026/0156046 A1
(43) Pub. Date: Jun. 4, 2026

(54) APPARATUS AND METHOD FOR CONTROLLING OPERATION AND CONFIGURATION OF RADIO ACCESS NETWORK COMPONENTS FOR ARTIFICIAL INTELLIGENCE/MACHINE LEARNING-BASED ENERGY SAVING IN WIRELESS COMMUNICATION SYSTEM

(71) Applicant: ELECTRONICS AND TELECOMMUNICATIONS RESEARCH INSTITUTE, Daejeon (KR)

(72) Inventors: Soo Jung JUNG, Daejeon (KR); Jee Hyeon Na, Daejeon (KR); Jung Mo Moon, Daejeon (KR); Kyoung Seok Lee, Daejeon (KR)

(21) Appl. No.: 19/402,464

(22) Filed: Nov. 26, 2025

(30) Foreign Application Priority Data
Nov. 29, 2024 (KR) 10-2024-0174731
Nov. 5, 2025 (KR) 10-2025-0165660

(51) Int. Cl. H04L 41/16; H04L 47/83; H04W 36/00

(52) U.S. Cl. CPC H04L 41/16; H04L 47/83; H04W 36/0072

(57) ABSTRACT

The present disclosure relates generally to wireless communication systems, and more particularly to an apparatus and method for controlling operation and configuration of radio access network components for AI/ML-based energy saving in a wireless communication system. An operation method of an intelligent controller according to the present disclosure configures a dataset including performance data of a plurality of cells constituting a network for training an AI/ML model, trains an AI/ML model for traffic load prediction using the dataset, obtains traffic load prediction values for each of the plurality of cells using the trained AI/ML model, sets thresholds for each of the plurality of cells based on statistical values of the dataset, and determines switch on or switch off operation of capacity cells by comparing the traffic load prediction values with the thresholds.

### CROSS REFERENCE TO RELATED APPLICATIONS

This application claims priority to Korean Patent Application No. 10-2024-0174731, filed on Nov. 29, 2024, and Korean Patent Application No. 10-2025-0165660, filed on Nov. 5, 2025, the entire contents of which are hereby incorporated by reference.

### BACKGROUND OF THE INVENTION

### Field of the Invention

The present disclosure relates generally to wireless communication systems, and more particularly to an apparatus and method for controlling operation and configuration of radio access network components for artificial intelligence/machine learning (AI/ML)-based energy saving in a wireless communication system.

### Description of the Related Art

In O-RAN (Open Radio Access Network), a RAN Intelligent Controller (RIC) and related applications (xApp, rApp) are defined for intelligent control of the RAN. A Non-Real-Time RIC (Non-RT RIC) and a Near-Real-Time RIC (Near-RT RIC) provide closed-loop control by collecting data, exchanging policies, and executing commands through O1, E2, and A1 interfaces. The background of the present invention includes limitations of fixed threshold-based approaches, and there is a need to enhance switch on/off decisions by setting cell-specific thresholds using statistical values of AI/ML training data and comparing them with traffic load prediction values.

Conventional approaches for energy saving in Radio Access Networks (RANs) use a fixed threshold-based method set by mobile communication network operators, where decisions about the operation and usage of network components are made at regular intervals T. Network components include cells, carriers, RF channels, physical resource blocks (PRBs), and cloud resources. Operation and usage decisions involve switch on/off operations and limiting usage to a portion of the total available resources. Switch on/off operations can target cells, carriers, and cloud resources, while limiting to a portion of available resources can target RF channels, PRBs, and cloud resources.

Conventional operations for switching specific cells on and off are performed based on fixed thresholds set by mobile communication network operators. If the threshold is set as a time value, cells are configured to be turned off during certain time periods and turned on during other specific time periods. Alternatively, if the threshold is set as a traffic load related value of the cell, the traffic load of the corresponding cell is monitored at regular intervals T, and the cell is turned off when it falls below predetermined threshold and turned on when it exceeds the threshold. At this time, user equipment (UEs) being served by the corresponding cell are moved to other cells, access to that cell is barred, and then the cell is turned off. Such control operations are repeatedly performed in T period units.

However, this approach is applied to the entire network without considering different traffic patterns of individual cells and adjacent cells, resulting in low efficiency. Therefore, AI/ML-based intelligent control technology can be introduced to apply more precise energy saving measures based on the traffic load of specific cells and related conditions of other cells.

AI/ML-based energy-efficient radio access network configuration aims to achieve maximum balance between system performance and energy saving effects by adopting AI/ML algorithms based on intelligent platforms, thereby achieving network energy saving and consumption reduction. This involves optimizing network energy consumption while appropriately maintaining network capacity by changing the operation and configuration of unutilized network components based on AI/ML-based network traffic load prediction.

O-RAN aims to transform the RAN into a more intelligent, open, virtualized, and interoperable radio access network, and defines AI/ML-based RAN Intelligent Controllers (RICs) and related applications (Apps) for intelligent control of the RAN. The RIC is a logical node that can collect information about cells where transmission and reception occur between user equipment (UEs) and base stations (O-eNB, O-CU, O-DU), and can be installed in a centralized server or base station (gNB). RICs are classified into Non-Real-Time (Non-RT) RICs with control time units of 1 second or more and Near-Real-Time (Near-RT) RICs with control time units between 10 ms and 1 second, according to the closed-loop control time unit for RAN configuration nodes. xApp, an application within the Near-RT RIC, controls related functions of E2 nodes (O-CU, O-DU). rApp, an application within the Non-RT RIC, provides analysis-related functions of the RAN and policy functions for RAN management using cell statistical information collected from E2 nodes. RICs and RAN configuration nodes (E2 nodes, O-RU) can propose procedures and parameters through O1 or E2 interfaces. O-RAN utilizes AI/ML for optimized energy saving and energy efficiency improvement in relation to control of operation and configuration of various network components at various time scales.

### SUMMARY OF THE INVENTION

Based on the above discussion, the present disclosure provides an apparatus and method for maximizing energy saving effects by setting cell-specific thresholds using statistical values of data used in artificial intelligence/machine learning (AI/ML) training in a wireless communication system.

Additionally, the present disclosure provides an apparatus and method for intelligently controlling operations of capacity cells by utilizing information of all cells constituting a network in a wireless communication system.

Additionally, the present disclosure provides an apparatus and method for determining switch on/off operations of cells through traffic load prediction and comparison with cell type-specific thresholds in a wireless communication system.

Additionally, the present disclosure provides an apparatus and method for achieving balance between energy saving and system performance by confirming handover possibility in a wireless communication system.

According to various embodiments of the present disclosure, an intelligent controller for energy saving in a wireless communication system configures a dataset including performance data of a plurality of cells constituting a network for training an AI/ML model, trains an AI/ML model for traffic load prediction using the dataset, obtains traffic load prediction values for each of the plurality of cells using the trained AI/ML model, sets thresholds for each of the plurality of cells based on statistical values of the dataset, and determines switch on or switch off operation of capacity cells by comparing the traffic load prediction values with the thresholds.

According to various embodiments of the present disclosure, for energy saving in a wireless communication system, an intelligent controller selects a capacity cell as a switch on candidate when the current state of the cell is an idle state and the traffic load prediction value obtained through an AI/ML model is equal to or greater than the threshold set for that capacity cell based on statistical values of the AI/ML training dataset, and also selects the capacity cell as a switch on candidate when the current state of the cell is an idle state and the traffic load prediction value is lower than the threshold of the capacity cell but the traffic load prediction value of an adjacent coverage cell exceeds the threshold of the coverage cell, and performs the switch on operation.

According to various embodiments of the present disclosure, an intelligent controller for energy saving in a wireless communication system configures a dataset including performance data of a plurality of cells constituting a network for training an AI/ML model, trains an AI/ML model for traffic load prediction using the dataset, obtains traffic load prediction values for each of the plurality of cells using the trained AI/ML model, sets thresholds for each of the plurality of cells based on statistical values of the dataset, and determines switch on or switch off operation of capacity cells by comparing the traffic load prediction values with the thresholds.

The apparatus and method according to various embodiments of the present disclosure enable maximization of energy saving effects by adaptively responding to changes in network environment compared to fixed threshold approaches by setting optimized thresholds for each cell using statistical values of AI/ML training datasets.

Additionally, the apparatus and method according to various embodiments of the present disclosure enable maintenance of service quality while achieving energy saving by performing switch on/off decisions comprehensively considering traffic load prediction of capacity cells and available resources of adjacent cells.

Additionally, the apparatus and method according to various embodiments of the present disclosure enable energy-efficient operation suited to real-time network conditions by performing closed-loop control using O-RAN-based intelligent controllers and application apps.

Effects obtainable from the present disclosure are not limited to the effects mentioned above, and other effects not mentioned will be clearly understood by those skilled in the art to which the present disclosure belongs from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates a configuration and operation of an energy saving system based on O-RAN intelligent controller and application apps according to an embodiment of the present disclosure.

FIG. 2 is a flowchart illustrating an operation method of an intelligent controller for AI/ML-based energy saving according to an embodiment of the present disclosure.

FIG. 3 is a flowchart illustrating a switch on decision process for capacity cells by an application app for AI/ML-based energy saving within an intelligent controller according to an embodiment of the present disclosure.

FIG. 4 is a diagram showing a configuration of an intelligent controller according to an embodiment of the present disclosure.

### DETAILED DESCRIPTION OF THE INVENTION

Terms used in the present disclosure are merely used to describe specific embodiments and may not be intended to limit the scope of other embodiments. Singular expressions may include plural expressions unless the context clearly indicates otherwise. Technical or scientific terms used herein may have the same meanings as commonly understood by one of ordinary skill in the technical field described in the present disclosure. Among terms used in the present disclosure, terms defined in general dictionaries may be interpreted as having meanings identical or similar to those in the context of related art, and are not interpreted as ideal or excessively formal meanings unless explicitly defined in the present disclosure. In some cases, even terms defined in the present disclosure cannot be interpreted to exclude embodiments of the present disclosure.

In various embodiments of the present disclosure described below illustrate hardware-based approaches as examples. However, since various embodiments of the present disclosure include technologies using both hardware and software, various embodiments of the present disclosure do not exclude software-based approaches.

In addition, in the detailed description and claims of the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

The present disclosure relates to an apparatus and method for encoding and retransmission of low density parity check codes in wireless communication systems.

Specifically, the present disclosure describes a technology for increasing channel coding gain by setting the starting point of a circular buffer so that self-decoding is possible for each retransmission data even in environments with high propagation blocking probability in wireless communication systems, and expanding the belief propagation range by utilizing an interleaver.

Terms referring to signals, terms referring to channels, terms referring to control information, terms referring to network entities, and terms referring to components of devices used in the following description are exemplified for convenience of description. Therefore, the present disclosure is not limited to the terms described below, and other terms with equivalent technical meanings may be used.

In addition, although the present disclosure describes various embodiments using terms used in some communication standards (e.g., 3GPP (3rd Generation Partnership Project)), this is merely an example for explanation. Various embodiments of the present disclosure can be easily modified and applied to other communication systems as well.

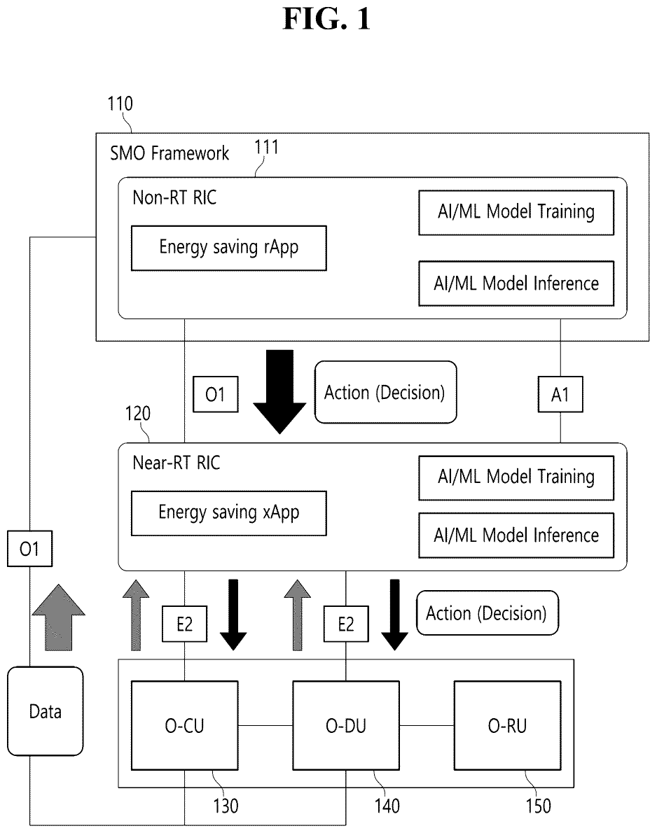

FIG. 1 illustrates a configuration of an energy saving system based on O-RAN intelligent controller and application apps according to an embodiment of the present disclosure.

Referring to FIG. 1, the energy saving system includes an SMO framework 110, a Non-Real-Time RIC (Non-RT RIC) 111, a Near-Real-Time RIC (Near-RT RIC) 120, an O-CU 130, an O-DU 140, and an O-RU 150.

The SMO framework 110 is a logical functional block that performs service management and orchestration functions in the O-RAN architecture. The Non-RT RIC 111 may be included within the SMO framework 110.

The Non-RT RIC 111 is an intelligent controller with a control cycle of 1 second or more, and includes multiple application apps that perform AI/ML Model Training functions and AI/ML Model Inference functions. An Energy saving rApp operates as one application app within the Non-RT RIC 111, which trains an AI/ML model using cell statistical information collected from E2 nodes and predicts traffic load through the trained model. The Non-RT RIC 111 communicates with the Near-RT RIC 120 and RAN configuration nodes through the O1 interface, performs control operation decisions (Actions) for energy saving, and delivers switch on/off commands. The Non-RT RIC 111 can also deliver policy (POLICY) information to the Near-RT RIC 120 through the A1 interface.

The Near-RT RIC 120 is an intelligent controller with a control cycle between 10 ms and 1 second, and includes multiple application apps that perform AI/ML model training functions and AI/ML model inference functions. An Energy saving xApp operates as one application app within the Near-RT RIC 120, which collects real-time performance data (Data) from the O-CU 130 and O-DU 140 through the E2 interface. The Near-RT RIC 120 trains AI/ML models and performs inference based on the collected data, and performs control operation decisions for energy saving. The Near-RT RIC 120 delivers control commands to the O-CU 130 and O-DU 140 through the E2 interface and communicates with the Non-RT RIC 111 through the O1 interface.

The O-CU 130 is a node that performs Central Unit functions in the O-RAN architecture, processing Radio Resource Control (RRC) and Packet Data Convergence Protocol (PDCP) layer functions. The O-CU 130 is connected to the Near-RT RIC 120 through the E2 interface to report performance data and receive control commands.

The O-DU 140 is a node that performs Distributed Unit functions in the O-RAN architecture, processing Radio Link Control (RLC), Medium Access Control (MAC), and PHY upper layer functions. The O-DU 140 is connected to the Near-RT RIC 120 through the E2 interface to report performance data and receive control commands.

The O-RU 150 is a node that performs Radio Unit functions in the O-RAN architecture, processing PHY lower layer and RF functions. The O-RU 150 is responsible for actual transmission and reception of radio signals.

According to the present disclosure, the energy saving application app within the Non-RT RIC 111 or Near-RT RIC 120 collects performance data of all cells constituting the network to train an AI/ML model, predicts traffic load of each cell through the trained model, and sets cell-specific thresholds using statistical values of the AI/ML training dataset. Thereafter, it determines switch on or switch off operation of capacity cells by comparing traffic load prediction values with thresholds, and delivers the corresponding control commands to RAN configuration nodes through O1 or E2 interfaces.

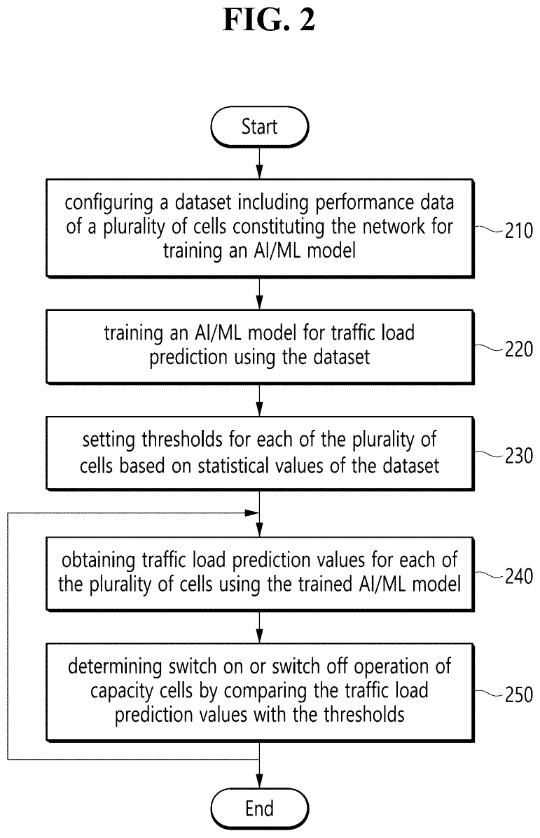

FIG. 2 is a flowchart illustrating an operation method of an intelligent controller for AI/ML-based energy saving according to an embodiment of the present disclosure.

Referring to FIG. 2, at step 210, the intelligent controller configures a dataset including performance data of a plurality of cells constituting the network for training an AI/ML model.

The dataset configured at step 210 includes performance data of all cells constituting the network, that is, coverage cells and capacity cells. The performance data may include cell-level performance metrics considering relevance to power consumption. According to one embodiment, the performance data may include at least one of physical resource block (PRB) usage, used PRB number, and average power. According to another embodiment, the performance data may additionally include at least one of PDCP PDU volume or UE throughput as data related to cell throughput.

The dataset configuration at step 210 may be performed in an offline manner using previously collected performance data or in an online manner using performance data generated in real-time. The offline manner is suitable for training an initial AI/ML model using past network operation data, and the online manner is suitable for adaptively updating the model to a network environment that changes in real-time.

At step 220, the intelligent controller trains an AI/ML model for traffic load prediction using the dataset.

The AI/ML model training at step 220 is performed for the purpose of traffic load prediction. The AI/ML model acquires the ability to predict future traffic load by learning past performance data patterns. According to one embodiment, the intelligent controller may perform AI/ML model training through an energy saving rApp within the Non-RT RIC. According to another embodiment, the intelligent controller may perform AI/ML model training through an energy saving xApp within the Near-RT RIC.

The AI/ML model can be implemented using various machine learning algorithms, and recurrent neural networks such as Long Short-Term Memory (LSTM) and Gated Recurrent Unit (GRU) suitable for time series data analysis, or Multi-Layer Perceptron, etc., may be used.

At step 230, the intelligent controller sets thresholds for each of the plurality of cells based on statistical values of the dataset.

The threshold setting at step 230 is performed differentially according to cell type. Cells are classified into coverage cells and capacity cells, and thresholds are set in different ways according to each type.

According to one embodiment, a threshold

$$( {TH}_{cap}^{i} )$$

for capacity cell i is set as shown in Equation 1 using the mean value (mᵢ) and standard deviation (σᵢ) of the training dataset for that cell:

$${TH}_{cap}^{i} = {m}_{i} \pm {w}_{cap} * {σ}_{i} \qquad [ Equation 1 ]$$

where

$${TH}_{cap}^{i}$$

is the threshold for capacity cell i, mᵢ is the mean value of the training dataset for capacity cell i, σᵢ is the standard deviation of the training dataset for capacity cell i, and w_{cap} is a weight for the standard deviation. The weight (w_{cap}) for the standard deviation can be adjusted according to the network operator's energy saving goals and service quality requirements, and may be set to values such as 0.5, 1, 2, etc. The selection of plus (+) or minus (−) sign determines whether to set the threshold higher or lower than the mean value.

According to another embodiment, a threshold

$$( {TH}_{cov}^{j} )$$

for coverage cells may be set to the same value for all coverage cells or to different values for each site.

When applying the same threshold to all coverage cells, it can be expressed as Equation 2.

$${TH}_{cap}^{i} = {TH}_{cov} \qquad [ Equation 2 ]$$

where TH_{cov} is a threshold commonly applied to all coverage cells and is determined considering the balance between power consumption and performance of the entire network. When applying different thresholds for each site, it can be expressed as Equation 3.

$${TH}_{cap}^{i} = {TH}_{cov}^{s} \qquad [ Equation 3 ]$$

where

$${TH}_{cov}^{s}$$

is a threshold applied to coverage cells belonging to site s and is determined considering statistical values of capacity cells located at the same site as the corresponding coverage cell.

At step 240, the intelligent controller obtains traffic load prediction values for each of the plurality of cells using the trained AI/ML model.

Traffic load prediction at step 240 is performed for all cells constituting the network. The intelligent controller uses current performance data of each cell as input to the trained AI/ML model to obtain prediction values for traffic load after a certain period. According to one embodiment, the intelligent controller may obtain traffic load prediction values at time (t+Δ), which is Δ time after the current time (t), using performance data at current time (t) as input. Δ can be set according to network operation policy and energy saving control cycle, and may be set to a value between several minutes and several tens of minutes, for example.

The traffic load prediction value indicates the degree of traffic load that each cell will experience in the future, and is used as basic information for determining switch on or switch off of cells in subsequent steps.

At step 250, the intelligent controller determines switch on or switch off operation of capacity cells by comparing the traffic load prediction values with the thresholds. The switch on or switch off operation decision at step 250 is performed considering the current state of each capacity cell and the traffic load prediction value. The state of a capacity cell is classified into an active state or an idle state. The active state means a state where the cell is turned on and providing service to terminals, and the idle state means a state where a cell is turned off and not providing service.

### [Switch Off Candidate Confirmation and Switch Off Operation Decision Procedure]

\textcircled{1} Among capacity cells whose current state is active, cells whose traffic load prediction value is less than the threshold of that cell are selected as candidates for switch off operation.
\textcircled{2} Handover possibility to neighbor cells is confirmed using neighbor cell information of the candidate cell. Handover is determined to be possible only when neighbor cells have more available resources than the traffic load prediction value of the candidate cell.
\textcircled{3} If handover is not possible, the candidate cell is excluded from the candidates.
\textcircled{4} If handover is possible, the capacity cell is switched off to transition to idle state, and if not possible, it is excluded from candidates.

According to one embodiment, when the traffic load prediction value of a capacity cell in an active state is lower than the threshold of that capacity cell, the application app within the intelligent controller selects that capacity cell as a switch off candidate. For the capacity cell selected as a switch off candidate, the intelligent controller confirms handover possibility to neighbor cells using neighbor cell information of that cell. Neighbor cells can be classified into fully covered neighbor cells or partially covered neighbor cells, and depending on the network operator's energy saving goals and service quality requirements, only fully covered neighbor cells may be considered when confirming handover possibility, or partially covered neighbor cells may also be included. Handover possibility is determined to be possible when neighbor cells have more available resources than the traffic load prediction value of the switch off candidate capacity cell. When handover is possible, the intelligent controller determines to switch off that capacity cell, hands over terminals being served by that cell to neighbor cells, and then switches off the cell. When handover is not possible, that capacity cell is excluded from switch off candidates and maintains the active state.

According to another embodiment, when the traffic load prediction value of a capacity cell in an idle state is equal to or greater than the threshold of that capacity cell, the intelligent controller selects that capacity cell as a switch on candidate and determines to perform switch on operation.

According to another embodiment, when the traffic load prediction value of a capacity cell in an idle state is lower than the threshold of that capacity cell but the traffic load prediction value of an adjacent coverage cell exceeds the threshold of the coverage cell, the intelligent controller selects that capacity cell as a switch on candidate. In this case, that capacity cell is selected according to specific criteria from among neighbor cells of the coverage cell. The specific criteria may include the degree of inter-cell coverage overlap, previous handover records, frequency band compatibility, etc. The capacity cell selected as a switch on candidate performs switch on operation and hands over some of the terminals connected to the coverage cell to that capacity cell to distribute the load of the coverage cell.

According to another embodiment, even when there is a capacity cell determined for switch off, if switch on of a surrounding capacity cell is necessary due to exceeding the threshold of a surrounding coverage cell but there is no capacity cell to switch on, the switch off decision for that capacity cell may be changed. This is to optimize energy saving while maintaining service quality of the entire network.

The switch on or switch off operation decision at step 250 is repeatedly performed at regular intervals (T). The control period (T) can be set as a multiple of the time unit (Δ) for traffic load prediction. For example, the control period can be set as T=n×Δ, in which case switch on or switch off operation can be determined using comparison of the average of multiple prediction values performed in time units (Δ) with the threshold, or using the number of times the criterion is satisfied based on comparison results of prediction values at each time unit (Δ) with the threshold.

In this specification, by applying the determination schema based on the average or the number of times the criterion is satisfied, an on/off decision reflecting the statistical characteristics of accumulated predictions is performed at each control period T.

According to the determination result of step 250, the intelligent controller delivers switch on or switch off control commands to corresponding RAN configuration nodes through the O1 interface or E2 interface.

According to one embodiment, the intelligent controller can continuously optimize thresholds through a closed-loop control method. That is, by collecting actual performance data according to the results of switch on or switch off operations and using this as retraining data for the AI/ML model, the accuracy of threshold setting can be improved. Additionally, by additionally utilizing the control operation results of cells based on thresholds in training the AI/ML model, training for the degree of switch on or switch off time intervals of cells can be added, and this can be utilized in determining control operations of cells.

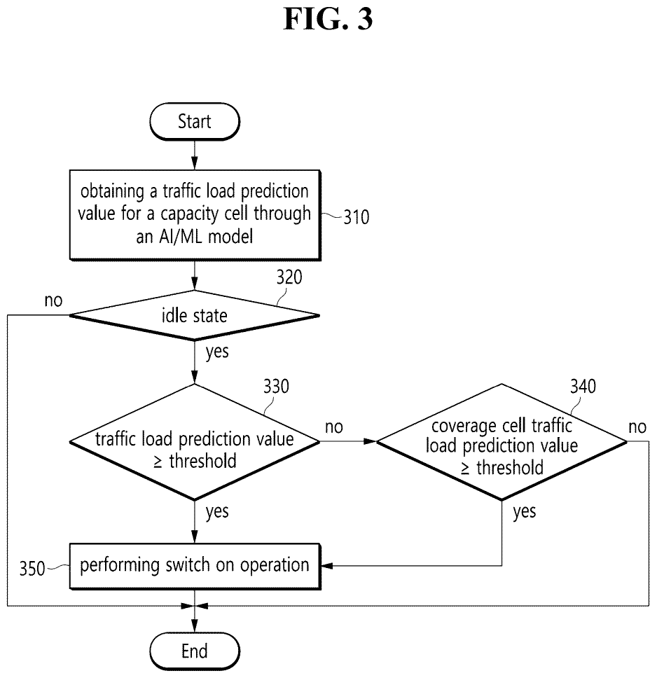

FIG. 3 is a flowchart illustrating a switch on decision process for capacity cells by an application app for AI/ML-based energy saving within an intelligent controller according to an embodiment of the present disclosure.

Referring to FIG. 3, at step 310, the application app obtains a traffic load prediction value for a capacity cell through an AI/ML model and a threshold set based on statistical values of the AI/ML training dataset.

At step 310, the traffic load prediction value is generated through the AI/ML model trained in the application app within the intelligent controller, and represents the expected traffic load of the corresponding capacity cell after a certain time from the current time. The threshold is a threshold for the capacity cell set using statistical values of the training dataset of the corresponding capacity cell, namely the mean value and standard deviation. Additionally, at step 310, the traffic load prediction value of an adjacent coverage cell and the threshold of the coverage cell may also be obtained.

At steps 320 and 330, the application app confirms whether the current state is an idle state and the traffic load prediction value is equal to or greater than the threshold of the capacity cell.

The determination at step 320 is performed by confirming whether the current state of the corresponding capacity cell is an idle state, and the determination at step 330 is performed by comparing whether the traffic load prediction value is equal to or greater than the threshold of the corresponding capacity cell. When this condition is satisfied (yes), since high traffic load is expected in the future for the corresponding capacity cell, it is determined that switch on is necessary to provide service, and the process proceeds to step 350.

At step 340, the application app confirms whether the current state is an idle state and the traffic load prediction value is lower than the threshold of the capacity cell (step 330 is “no”), but the traffic load prediction value of the coverage cell exceeds the threshold of the coverage cell.

The determination at step 340 is performed by comparing whether the traffic load prediction value of the adjacent coverage cell exceeds the threshold of the coverage cell. When this condition is satisfied (yes), although the traffic load of the corresponding capacity cell itself is predicted to be low, since the traffic load of the adjacent coverage cell exceeds the threshold and an overload state is expected, switch on of the corresponding capacity cell is determined to be necessary to distribute the load of the coverage cell, and the process proceeds to step 350.

According to one embodiment, the capacity cell selected as a switch on candidate at step 340 is selected according to specific criteria from among neighbor cells of the coverage cell. The specific criteria may include the following.

First, the degree of inter-cell coverage overlap. The more the geographical coverage between the capacity cell and the coverage cell overlaps, the easier it is for terminals to handover, so a capacity cell with a high degree of coverage overlap may be preferentially selected.

Second, previous handover records. If there is a history of frequent handovers from the corresponding coverage cell to the corresponding capacity cell in the past, it is highly likely that terminals will move smoothly to the corresponding capacity cell, so it may be preferentially selected.

Third, frequency band compatibility. When the coverage cell and the capacity cell use the same or compatible frequency bands, the burden of frequency readjustment of the terminal is small, so it may be preferentially selected.

According to another embodiment, when a plurality of capacity cells exist as neighbor cells for one coverage cell, a weight-based score may be calculated by comprehensively considering the specific criteria described above, and the capacity cell with the highest score may be selected as a switch on candidate.

If the condition of step 330 is not satisfied (no), since switch on is unnecessary, the corresponding capacity cell maintains the idle state and terminates.

At step 350, the application app performs switch on operation for the capacity cell selected as a switch on candidate.

The switch on operation at step 350 means transitioning the corresponding capacity cell from idle state to active state. Specifically, activates radio the capacity cell resources, transmits signals so that terminals can access the corresponding cell, and informs the network that the corresponding cell is in a serviceable state.

According to one embodiment, the capacity cell switched on by the condition of step 330 is expected to have high traffic load by itself, so it starts accepting connections from terminals within the coverage area of the corresponding cell immediately upon switch on.

According to another embodiment, the capacity cell switched on by the condition of step 340 is for load distribution of the adjacent coverage cell, so after performing the switch on operation, the process of handing over some of coverage cell to the terminals connected to the corresponding capacity cell is additionally performed. Terminals subject to handover may be selected considering the signal quality of the corresponding capacity cell, the location of the terminal, the service requirements of the terminal, etc. When handover is completed, the traffic load of the coverage cell decreases, and the capacity cell processes some traffic, thereby balancing the load of the entire network.

According to another embodiment, after the switch on operation is completed at step 350, the actual traffic load and performance data of the corresponding capacity cell are fed back to the intelligent controller and can be used as retraining data for the AI/ML model. Through this, the intelligent controller can continuously improve the accuracy of switch on decisions.

According to another embodiment, the switched-on capacity cell maintains an active state for a certain period of time, and thereafter, whether to switch off may be determined again through traffic load prediction and threshold comparison. Through such repetitive control, the network can maximize energy efficiency while adaptively responding to traffic patterns that change over time.

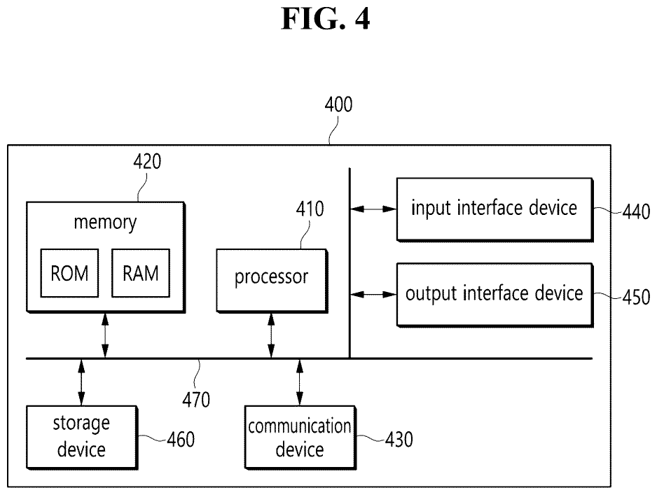

FIG. 4 is a diagram showing a configuration of an intelligent controller according to an embodiment of the present disclosure.

Referring to FIG. 4, the intelligent controller 400 may include at least one processor 410, a memory 420, and a communication device 430 connected to a network to perform communication. Additionally, the intelligent controller 400 may further include an input interface device 440, an output interface device 450, a storage device 460, etc. Each of the components included in the intelligent controller 400 is connected by a bus 470 and can communicate with each other.

However, each of the components included in the intelligent controller 400 may not be connected through a common bus 470 but may be connected through individual interfaces or individual buses centered on the processor 410. For example, the processor 410 may be connected to at least one of the memory 420, the communication device 430, the input interface device 440, the output interface device 450, and the storage device 460 through a dedicated interface.

The processor 410 can execute program commands stored in at least one of the memory 420 and the storage device 460. The processor 410 may mean a central processing unit (CPU), a graphics processing unit (GPU), or a dedicated processor on according to embodiments of the present which methods disclosure are performed.

According to one embodiment, the processor 410 is configured to perform the operation method of the intelligent controller described in FIG. 2 of the present disclosure. Specifically, the processor 410 configures a dataset including performance data of a plurality of cells constituting a network for training an AI/ML model, trains an AI/ML model for traffic load prediction using the dataset, obtains traffic load prediction values for each of the plurality of cells using the trained AI/ML model, sets thresholds for each of the plurality of cells based on statistical values of the dataset, and may be configured to determine switch on or switch off operation of capacity cells by comparing the traffic load prediction values with the thresholds.

According to another embodiment, the processor 410 may execute an energy saving application app to perform the energy saving control operation of the present disclosure. The energy saving application app may be implemented as an rApp in the case of Non-RT RIC and as an xApp in the case of Near-RT RIC.

Each of the memory 420 and the storage device 460 may be composed of at least one of a volatile storage medium and a non-volatile storage medium. For example, the memory 420 may be composed of at least one of read only memory (ROM) and random access memory (RAM).

According to one embodiment, the memory 420 may store program code for training and inference of AI/ML models, parameters of AI/ML models, training datasets, performance data of each cell, threshold information, traffic load prediction values, etc. The memory 420 may be used as working memory that temporarily stores data that the processor 410 must access and process in real-time.

The storage device 460 may store data that needs to be kept for a long time. According to one embodiment, the storage device 460 may store past performance data history, trained AI/ML models, history of energy saving control operations, cell configuration information, neighbor cell information, etc. The storage device 460 may be implemented as a hard disk drive (HDD), solid state drive (SSD), etc.

The communication device 430 may be connected to a network through wired communication or wireless communication and perform communication with RAN configuration nodes. According to one embodiment, the communication device 430 may communicate with RAN configuration nodes through the O1 interface. According to another embodiment, the communication device 430 may communicate with O-CU and O-DU through the E2 interface. According to another embodiment, the communication device 430 may perform communication between the Non-RT RIC and the Near-RT RIC through the A1 interface. Therefore, the communication device 430 performs the function of exchanging data with RAN configuration nodes through the O1/E2/A1 interfaces and delivering cell switch on/off control commands according to the ‘Action (Decision)’ of the intelligent controller.

The communication device 430 performs the function of collecting performance data from RAN configuration nodes and delivering the determined switch on or switch off control commands to RAN configuration nodes. The communication device 430 can support various communication methods such as Ethernet, fiber optic communication, and wireless communication.

The input interface device 440 can receive input from network operators or administrators. According to one embodiment, the input interface device 440 may include a keyboard, mouse, touchscreen, etc., and may be used by network operators to input energy saving policies, threshold setting parameters, AI/ML model training parameters, etc.

The output interface device 450 can output information such as the operation state of the intelligent controller, prediction results of the AI/ML model, energy saving effects, etc. According to one embodiment, the output interface device 450 may include a display, printer, speaker, etc., and may be used to provide visual or auditory information to network operators.

The bus 470 provides a data transmission path between each component of the intelligent controller 400. The bus 470 may include a system bus, data bus, address bus, etc., and supports high-speed data transmission between each component.

According to one embodiment, the intelligent controller 400 may be implemented as a Non-RT RIC of the O-RAN architecture. In this case, the intelligent controller 400 is included in the SMO framework and performs energy saving control with a control cycle of 1 second or more.

According to another embodiment, the intelligent controller 400 may be implemented as a Near-RT RIC of the O-RAN architecture. In this case, the intelligent controller 400 performs energy saving control with a control cycle between 10 ms and 1 second.

According to another embodiment, the configuration of the intelligent controller 400 of the present disclosure may also be equally applied to a capacity cell control device. The capacity cell control device may be included in the O-CU or O-DU, and may perform switch on or switch off decisions by itself based on the traffic load prediction value and threshold received from the intelligent controller, or may perform the role of executing control commands of the intelligent controller.

Methods according to embodiments described in the claims or specification of the present disclosure may be implemented in the form of hardware, software, or a combination of hardware and software.

When implementing with software, a computer-readable storage medium storing one or more programs (software modules) may be provided. One or more programs stored in the computer-readable storage medium are configured for execution by one or more processors within an electronic device. The one or more programs include instructions that cause the electronic device to execute methods according to embodiments described in the claims or specification of the present disclosure.

Such programs (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage, magnetic cassette. Alternatively, it may be stored in memory composed of a combination of some or all of these. Also, each component memory may be included in plurality.

Also, the program may be stored in an attachable storage device that can be accessed through a communication network such as the Internet, Intranet, local area network (LAN), wide area network (WAN), or storage area network (SAN), or a communication network composed of a combination thereof. Such a storage device may access a device performing embodiments of the present disclosure through an external port. Also, a separate storage device on the communication network may access the device performing embodiments of the present disclosure.

In the specific embodiments of the present disclosure described above, components included in the disclosure are expressed in singular or plural according to the specific embodiment presented. However, singular or plural expressions are selected appropriately for the situation presented for convenience of description, and the present disclosure is not limited to singular or plural components, and even components expressed in plural may be composed in singular, or even components expressed in singular may be composed in plural.

Meanwhile, although specific embodiments have been described in the detailed description of the present disclosure, various modifications are possible without departing from the scope of the present disclosure. Therefore, the scope of the present disclosure should not be limited to the described embodiments but should be determined by the scope of the claims described below as well as equivalents to the scope of these claims.

What is claimed is:

1. A method for energy saving by an intelligent controller in a wireless communication system, the method comprising:
configuring a dataset including performance data of a plurality of cells constituting a network for training an artificial intelligence/machine learning (AI/ML) model;
training an AI/ML model for traffic load prediction using the dataset;
setting thresholds for each of the plurality of cells based on statistical values of the dataset; obtaining traffic load prediction values for each of the plurality of cells using the trained AI/ML model; and
determining switch on or switch off operation of capacity cells by comparing the traffic load prediction values with the thresholds.

2. The method of claim 1, wherein the performance data includes at least one of physical resource block (PRB) usage, used PRB number, average power, Packet Data Convergence Protocol (PDCP) Packet Data Unit (PDU) volume, or user equipment (UE) throughput.

3. The method of claim 1, wherein setting the thresholds comprises: setting thresholds for capacity cells using statistical values of the dataset, and
wherein the threshold for a capacity cell is determined using a mean value, a standard deviation, and a weight among the statistical values of the dataset.

4. The method of claim 3, wherein setting the thresholds further comprises: setting the same threshold for all coverage cells or setting different thresholds for each site for coverage cells.

5. The method of claim 1, wherein determining the switch on or switch off operation comprises: selecting a capacity cell as a switch off candidate when a traffic load prediction value of the capacity cell in an active state is lower than the threshold of the capacity cell;
determining handover possibility by checking available resources of neighbor cells of the capacity cell; and
determining to switch off the capacity cell when handover is possible.

6. A method for controlling capacity cells for energy saving in a wireless communication system, the method comprising:
receiving a traffic load prediction value obtained through an AI/ML model and a threshold set based on statistical values of an AI/ML training dataset;
being selected as a switch on candidate when a current state is an idle state and the traffic load prediction value is equal to or greater than a threshold of a capacity cell; being selected as a switch on candidate when the current state is an idle state and the traffic load prediction value is lower than the threshold of the capacity cell but a traffic load prediction value of an adjacent coverage cell exceeds a threshold of the coverage cell; and
performing a switch on operation.

7. The method of claim 6, further comprising: selecting a switch on target capacity cell according to specific criteria from among neighbor cells of the coverage cell when the traffic load prediction value of the coverage cell exceeds the threshold of the coverage cell, and
wherein the specific criteria include at least one of inter-cell coverage, previous handover records, or frequency band.

8. The method of claim 6, further comprising: handing over some of terminals connected to the coverage cell to the capacity cell after performing the switch on operation.

9. The method of claim 1, wherein: the training of the AI/ML model is performed in an offline manner or an online manner, and the thresholds are updated through performance-based online iteration and optimization.

10. The method of claim 1, wherein: the intelligent controller is a Non-Real-Time RAN Intelligent Controller (RIC) or a Near-Real-Time RIC of Open Radio Access Network (O-RAN) architecture, and
determining the switch on or switch off operation is performed by an energy saving application app within the RIC.

11. An intelligent controller for energy saving in a wireless communication system, the intelligent controller comprising:
a transceiver; and a processor operatively connected to the transceiver,
wherein the processor is configured to: configure a dataset including performance data of a plurality of cells constituting a network for training an AI/ML model, train an AI/ML model for traffic load prediction using the dataset, set thresholds for each of the plurality of cells based on statistical values of the dataset, obtain traffic load prediction values for each of the plurality of cells using the trained AI/ML model, and determine switch on or switch off operation of capacity cells by comparing the traffic load prediction values with the thresholds.

12. The intelligent controller of claim 11, wherein the performance data includes at least one of PRB usage, used PRB number, average power, PDCP PDU volume, or UE throughput.

13. The intelligent controller of claim 11, wherein the processor is configured to:
set thresholds for capacity cells using statistical values of the dataset, and
wherein the threshold for a capacity cell is determined using a mean value, a standard deviation, and a weight among the statistical values of the dataset.

14. The intelligent controller of claim 13, wherein the processor is configured to:
set the same threshold for all coverage cells or set different thresholds for each site for coverage cells.

15. The intelligent controller of claim 11, wherein the processor is configured to:
select a capacity cell as a switch off candidate when a traffic load prediction value of the capacity cell in an active state is lower than the threshold of the capacity cell, determine handover possibility by checking available resources of neighbor cells of the capacity cell, and determine to switch off the capacity cell when handover is possible.
